(19) United States
(12) Patent Application Publication
(10) Pub. No.: US 2026/0252978 A1
(43) Pub. Date: Aug. 27, 2026

(54) INTERNAL PROCESS ESTIMATION SYSTEM AND INTERNAL PROCESS ESTIMATION METHOD

(71) Applicant: Hitachi, Ltd., Tokyo (JP)

(72) Inventor: Takeshi Nakayama, Tokyo (JP)

(21) Appl. No.: 19/536,527

(22) Filed: Feb. 11, 2026

(30) Foreign Application Priority Data
Feb. 25, 2025 (JP) 2025-028451

(51) Int. Cl. G06Q 10/06; G06F 16/2457; G06N 20/00; G06N 20/20

(52) U.S. Cl. CPC G06Q 10/06; G06F 16/24578; G06N 20/00; G06N 20/20

(57) ABSTRACT

According to an aspect of the present invention, an internal process estimation system includes a search unit, an actual measured value input unit, and an output unit. The search unit applies, in a plurality of orders, a plurality of types of element models to a plurality of element regions of a virtual model divided into the plurality of element regions continuously in a single direction and creates a plurality of virtual models that simulate a process of a state transition from a first state to a second state of an actual apparatus. The actual measured value input unit inputs an actual measured value in the second state of the actual apparatus. The search unit evaluates the virtual model based on a difference between predicted data output by inputting a value based on the first state to the plurality of virtual models and the actual measured value. The output unit outputs a result evaluated by the search unit.

### BACKGROUND OF THE INVENTION

The present invention relates to a technique for estimating an internal process of a manufacturing apparatus or the like.

With advancement of mass production technology, inspection technology, and process informatics, machine learning-related technology is used to propose a process condition for manufacturing equipment (for example, a rotary kiln, a twin-screw extruder, or the like) that has low transparency of an internal state of an apparatus and tend to rely on the experience of skilled workers. By using an AI model trained on knowledge of a process condition accumulated in the past, it has become possible to reduce the number of times of experimental manufacturing required before mass production at the stage of development of a process for a new material or the like.

For example, Japanese Unexamined Patent Application Publication No. 2024-066339 discloses a process estimation apparatus that includes a regression model creation processing unit that performs machine learning on a relationship of process data and creates a regression model representing a correlation between these data, and a process estimation processing unit that uses the regression model created by the regression model creation processing unit to estimate the process data to be estimated.

Japanese Unexamined Patent Application Publication (Translation of PCT Application) No. 2007-534038 discloses a method for optimizing a sequentially combined process using a surrogate model.

### SUMMARY OF THE INVENTION

Even an experienced engineer may find it difficult to understand why a process condition proposed using a machine learning model worked well or what has happened as an internal process. In most cases, it is difficult to know the true flow of a physical internal process that reproduces a result of a small number of actual machine experiment data pieces, and it is difficult for an unskilled engineer to even present a possible candidate as a flow of the internal process.

In a case where a simulator that simulates the process on a computer is present, a user deductively assembles a possible physical model in expected order and performs calculation (for example, melting of a solid to heating of a liquid to a chemical reaction). The accuracy of this calculation is often indirectly checked by checking that a difference between a result of the calculation and already obtained actual machine experiment data is small.

In a case where the difference between the result of the calculation and the actual machine experiment data is large, a work process of reviewing a calculation condition, such as a setting of the physical model, and checking the difference between a calculation result under the next calculation condition and the actual machine experiment data is repeated. However, in this work process, the user needs to have some knowledge of the process and postulate a plausible candidate for the order of physical processes. Proposing a plausible candidate for the order of the physical processes is not easy for an unskilled engineer. Therefore, a technique for estimating and visualizing the order of unknown internal processes is desirable.

According to an aspect of the present invention, an internal process estimation system includes a search unit, an actual measured value input unit, and an output unit. The search unit applies, in a plurality of orders, a plurality of types of element models to a plurality of element regions of a virtual model divided into the plurality of element regions continuously in a single direction and creates a plurality of virtual models that simulate a process of a state transition from a first state to a second state of an actual apparatus. The actual measured value input unit inputs an actual measured value in the second state of the actual apparatus. The search unit evaluates the virtual model based on a difference between predicted data output by inputting a value based on the first state to the plurality of virtual models and the actual measured value. The output unit outputs a result evaluated by the search unit.

According to another aspect of the present invention, an internal process estimation method is executed by an information processing apparatus that includes a search unit, an actual measured value input unit, and an output unit. The search unit applies, in a plurality of orders, a plurality of types of element models to a plurality of element regions of a virtual model divided into the plurality of element regions continuously in a single direction and creates a plurality of virtual models that simulate a process of a state transition from a first state to a second state of an actual apparatus. The actual measured value input unit inputs an actual measured value in the second state of the actual apparatus. The search unit evaluates the virtual model based on a difference between predicted data output by inputting a value based on the first state to the plurality of virtual models and the actual measured value. The output unit outputs a result evaluated by the search unit.

It is possible to estimate and visualize the order of unknown internal processes.

### BRIEF DESCRIPTION OF THE DRAWINGS

FIG. 1 is a schematic sectional diagram of a twin-screw extruder,

FIG. 2 is a conceptual diagram illustrating a surrogate model database according to an embodiment,

FIG. 3A is a schematic diagram illustrating an input and output format of a surrogate model used in the embodiment,

FIG. 3B is a schematic diagram illustrating another input and output format of the surrogate model used in the embodiment,

FIG. 4 is a block diagram illustrating a system configuration according to the present invention,

FIG. 5 is an explanatory diagram briefly illustrating an outline of the embodiment,

FIG. 6 is an explanatory diagram specifically illustrating the outline of the embodiment,

FIG. 7 is a graph illustrating an example of a visualization method according to the embodiment,

FIG. 8 is a flowchart illustrating a procedure from start to outputting of an estimated internal process permutation,

FIG. 9 is block diagram illustrating an example of a hardware configuration of an information processing apparatus,

FIG. 10 is a block diagram illustrating a program and data stored in a storage device, and

FIG. 11 is a block diagram illustrating an operation of an internal process estimation process.

### DETAILED DESCRIPTION OF THE PREFERRED EMBODIMENTS

Hereinafter, embodiments of the present invention will be described with reference to the drawings. However, the present invention is not to be construed as being limited to the description of the following embodiments. It will be easily appreciated by those skilled in the art that a specific configuration according to the present invention can be modified without departing from the spirit or gist of the present invention. In addition, the positions, sizes, shapes, and the like of respective components illustrated in the drawings in the present specification may not indicate the actual positions, sizes, shapes, and the like in order to easily understand the present invention. Therefore, the present invention is not limited to the positions, sizes, shapes, and the like disclosed in the drawings and the like.

In configurations of the embodiments described below, the same portions or portions having similar functions are denoted by the same reference signs in different drawings, and redundant explanations may be omitted.

In a case where a plurality of elements having the same function or similar functions are present, the elements will be described using the same reference sign with different subscripts. In a case where a plurality of elements do not need to be distinguished, the elements may be described without subscripts.

The terms “first,” “second,” “third,” and the like used in the present specification are used to identify components and do not necessarily limit the number, order, or content of the components. In addition, a number for identifying a component is used in each context, and a number used in one context does not necessarily indicate the same configuration in another context. Further, this does not preclude a component identified by a certain number from having a function of a component identified by another number.

Techniques described in the embodiments can contribute to solving the problem of difficulty in estimating the order of internal processes of a manufacturing apparatus. An example of configurations according to the embodiments is a permutation optimization calculation system that uses a virtual model in which a section from a raw material inlet to an outlet is divided into a plurality of element regions continuously in a single direction, and components of the system are outlined as follows.
(1) A surrogate model database including a plurality of surrogate regression models (element models) assignable to the respective element regions.
(2) An input unit that inputs a measured value of a substance at the outlet.
(3) A search unit that searches for a permutation of the regression models so as to minimize an evaluation function based on a difference between the measured value of the substance and predicted data output by an integrated model obtained by serially combining two or more of the regression models included in the surrogate model database.
(4) An output unit that outputs a result of calculation by the search unit for optimization of the permutation of the regression models.

With this configuration, in a processing process for which the simulation cost is relatively lower than the cost of acquiring actual machine experiment data, it is possible to display a plausible candidate for the order of processes for a small amount of actual machine experiment data by utilizing various surrogate models trained on simulation data as element models. Specifically, the system comprehensively examines a permutation of the surrogate models and outputs a ranking of a combination of models that best explain a small amount of experimental data. Therefore, a user can estimate the order of internal processes of a processing apparatus from a trend in output top-ranked model permutations.

### First Embodiment

In a first embodiment, a twin-screw extruder is used as a manufacturing apparatus for manufacturing a plastic material, and a situation is considered in which, under an operating condition used to optimize the quality of a plastic resin to be ejected, candidates for physical processes to which the resin is subjected before being ejected are presented based on the processing state of the resin inside the apparatus.

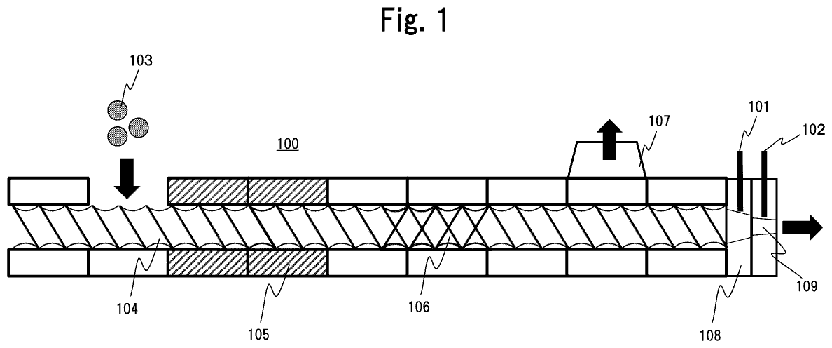

FIG. 1 is a schematic diagram illustrating an internal state of the twin-screw extruder as viewed from the side of the twin-screw extruder. It is difficult to accurately measure the state of the resin being processed in the twin-screw extruder 100. One of the main reasons for this is that the interior of the twin-screw extruder 100 is sealed and thus the visibility is limited. Further, since work is performed under a high temperature and a high pressure, mass production equipment requires a long-term continuous operation, it is known that it is difficult to install a measurement device inside, and if the measurement device is installed, there is a concern about the accuracy of measurement data. Normally, a thermometer 101 and a pressure gauge 102 are disposed near the outlet of the twin-screw extruder 100, but a measurement device is not disposed to directly observe an internal process of the apparatus.

The twin-screw extruder 100 needs to grasp process parameters important for the quality of a manufactured product, such as the adjustment of material heating and an amount (throughput) of ejection per unit time, and a screw configuration. However, means for directly measuring an internal condition is limited, and thus it is difficult to obtain the above-described information and a guideline for improving quality, and technological development is underway to optimize operating condition parameters using machine learning techniques.

In general, a twin-screw extruder is large mass production equipment. A small twin-screw extruder consumes a raw material of several kilograms per hour, and a medium to large twin-screw extruder consumes a raw material of several hundred kilograms per hour. Therefore, it is not easy to carefully examine what important process parameters are by using a single-factor testing method.

An operating condition parameter optimized using a machine learning model often results in a condition setting that is difficult for an experienced engineer for the twin-screw extruder to understand. This is due to the fact that when the machine learning model is trained, it is possible to find a complex pattern and correlation from training data that is difficult for humans to grasp intuitively. Therefore, when an operating condition setting suggested by the machine learning model causes a problem with the manufacturing apparatus or the user determines that a good result has been obtained by chance, it is difficult to obtain a guidance on how to adjust the operating condition next.

Specifically, it is considered what physical processes occur inside the apparatus before an extrudate is ejected in a process of feeding a raw material into the twin-screw extruder 100 and performing resin kneading. First, a raw material 103 is fed in a solid form into the twin-screw extruder 100 from an upstream inlet of the twin-screw extruder 100. This solid raw material is conveyed by a conveyance screw 104 to a melting zone 105 where a cylinder has been heated, and is melted into a fluid molten resin in the melting zone 105.

The molten resin is conveyed while being continuously heated in the cylinder, and reaches a kneading zone 106. In the kneading zone 106, the molten resin is subjected to a strong shear stress, which causes a chemical change and increases the viscosity of the molten resin. Thereafter, the molten resin is passed under a degassing port 107 again by the conveyance screw 104, and reaches a die 108 while a gas component in the molten resin is removed.

Since a thin flow path is present in the die 108, the molten resin is ejected from the outlet 109 while being subjected to a strong pressure from the resin remaining immediately before the die 108. During the ejection, the temperature and pressure of the ejected resin are constantly measured by the thermometer 101 and the pressure gauge 102, respectively.

However, unlike the temperature and pressure at the outlet, the states and order of the physical processes occurring inside the extruder may not be able to be constantly directly observed, and are expected to some extent by a user, who is an experienced engineer, as changes in the internal state based on the screw configuration of the extruder and a setting for the temperature of the cylinder of the extruder. Since many factors cannot be actually observed, it is not easy to answer a question such as, “Hasn't the solid raw material reached the kneading zone before being fully dissolved due to some reason, such as insufficient heating?” or “Has degassing already begun in a resin portion present in the melting zone since the internal filling rate is low?”. The present embodiment provides a solution to this question with some degree of reliability. The application of the present embodiment is considered to understand the internal processes of the twin-screw extruder 100.

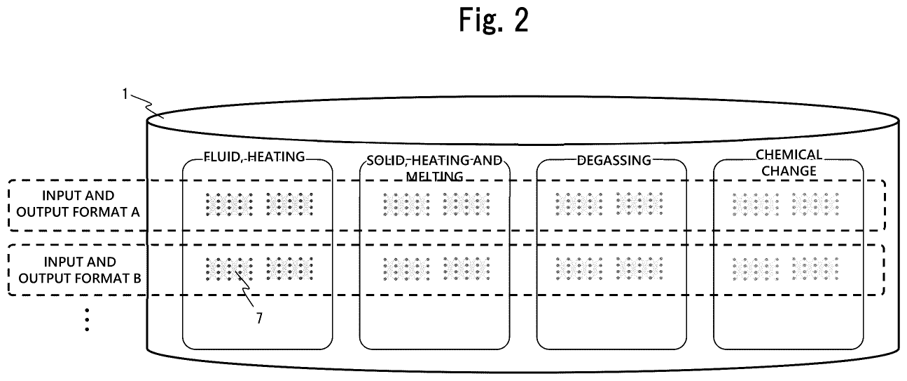

FIG. 2 illustrates a management mode of the surrogate models included in the surrogate model database 1 applied to the embodiment. In the surrogate model database 1, a surrogate model trained on a group of simulation data obtained by a calculation method such as a three-dimensional finite element method is stored in advance. The surrogate model is a method for substituting machine learning for physical simulation, and a general method for creating the surrogate model is known.

Examples of a substance handled by the twin-screw extruder include a fluid and a fine powder, and it is conceivable to numerically calculate an equation of motion in order to simulate behaviors of the fluid and the fine powder inside the twin-screw extruder. The numerical calculation for the simulation that accurately reproduces the movement of the fluid and the fine powder takes time, but by using results of the simulation as training data to train the surrogate model, it is possible to generate the surrogate model as an estimation model that quickly substitutes for the simulation.

The type of surrogate model is basically assumed to be a neural network model, but the surrogate model may be a surrogate model constructed by machine learning, a regression model that can analytically describe the relationship between values, such as a multiple regression model or a model that can be expressed by a known analytical physical formula or the like. In the present embodiment, the surrogate model is used as an example, but other types of models can also be used as long as the models are capable of simulating physical phenomena at a high speed. Simulation data is generally used as the training data for the surrogate model because it is advantageous in terms of cost, but experimental data may also be used as the training data.

In the surrogate model database 1, various surrogate models 7 are managed from two perspectives, which are physical process element names and input and output formats. In the present embodiment, four candidate physical processes which are a liquid heating process, a solid heating and melting process, a degassing process, and a chemical change process are provided, and the four processes are managed. In FIG. 2, two types of input formats, which are an input format A and an input format B, are assumed. There may be provided more or fewer physical processes and input forms than in this example.

As is known, the surrogate models are models that substitute for various physical simulations. Prerequisite conditions and parameters can be freely set for the physical simulations, and thus the physical simulations have a high degree of freedom. However, the physical simulations impose a heavy processing load and it is difficult to perform the physical simulations at a high speed. Therefore, by performing machine learning using the input and output of the physical simulations as training data, an inference model is generated and used to substitute for the physical simulations.

The surrogate models 7 may be generalized models that are applicable to multiple types of apparatuses. To enable highly accurate analysis, a model specific to a particular apparatus may be created (so-called custom-made).

For example, when the twin-screw extruder as illustrated in FIG. 1 is specifically considered, various screw shapes are available for the twin-screw extruder. Specifically, there are shapes such as a full-flight screw, a kneading screw, and a mixing screw, and surrogate models are prepared based on separate simulations. There are three further types of kneading screws (forward kneading FK, neutral kneading NK, and back kneading BK), and thus it is conceivable to prepare five types of surrogate models. Further, the kneading screws are classified into screws based on pitches (for example, 5 mm and 10 mm) of screw threads, and the extent to which differences in shape are pursued for classification creates a trade-off between precision and cost. In the example illustrated in FIG. 2, each physical model category for each input and output format includes two models corresponding to a full-flight screw and a kneading screw.

In the example illustrated in FIG. 2, the four physical processes are modeled, but the types of models are not limited thereto. A physical simulation that is based on a model has a high degree of freedom, and therefore can be used as a surrogate model as needed according to the user's purpose and constraints. For example, various categories may be present in the physical process of “chemical change”. There may be various categories, such as a change in molecular weight due to polymerization of a single chemical species, a chemical reaction between two chemical species, and degradation or decomposition of resin due to a high temperature. An appropriate physical process model may be used according to an apparatus and a material that the user considers. The processes can be categorized into categories such as “heating”, “melting”, “degassing”, “polymerization”, and “decomposition”. It is also possible to prepare different models for the accuracy of the surrogate models and the training data.

For example, in the case of the twin-screw extruder 100 illustrated in FIG. 1, when the length of a flow path of the apparatus is L and the number of element regions is N, in a custom-made surrogate model, each surrogate model may be configured to perform a physical simulation when a material moves a distance of L/N. Each of the element regions is a region in which a single surrogate model substitutes for a physical phenomenon. In this case, the number N is determined based on the design of the model, and if N is to be halved, two identical models combined in series are used as one unit and applied to the element region.

In addition, in the example of the twin-screw extruder, the specifications of the apparatus are largely affected by the diameter of the cylinder of the flow path and the shape of a screw. The shape of the screw is described above. Since the diameter of the cylinder is limited and is generally the external shape of the screw plus a predetermined value, the shape (and the diameter) of the screw is important when variations in the surrogate model are considered.

In the example of the twin-screw extruder, the length of the screw is usually expressed as L/D. L is the length of the screw, and D is the diameter of the screw. When this system is used, it is preferable that N be set to be equal to the number of screw pieces or a multiple of the number of screw pieces. For example, if all the screw pieces have a length of L/D=1, the number of screw pieces that can be placed in an apparatus having L/D=40 is 40. In this case, it is conceivable to set N to 40 or 80 in a case where this system is operated.

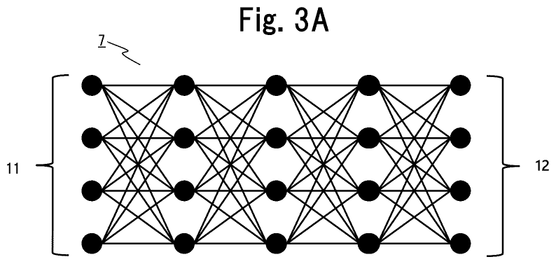

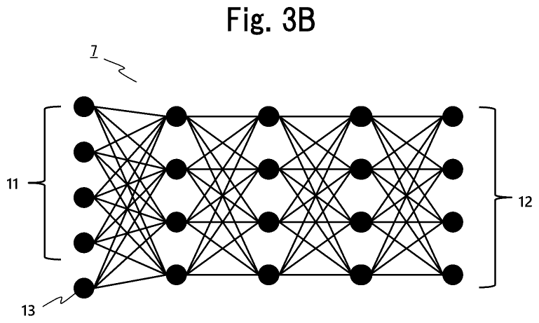

FIGS. 3A and 3B schematically illustrate two types of input formats. Two main types of input and output formats are present. As illustrated in FIG. 3A, one of the types is a pattern in which an output format and an input format of the surrogate model 7 are the same. That is, an input substance state quantity 11 and an output substance state quantity 12 become the same.

As illustrated in FIG. 3B, the other one of the types is a pattern in which an input format of the surrogate model 7 includes all of an output format of the surrogate model 7 and an operating condition D(x) depending on a position x where the surrogate model is disposed is received as a part of input. That is, the input substance state quantity 11 is the sum of the output substance state quantity 12 and an operation parameter 13.

Examples of the input substance state quantity 11 and the output substance state quantity 12 include physical quantities such as the temperature, the pressure, the viscosity, the flow rate, the temperature distribution (dispersion), or the shape of a particle of a second phase (the phase with a smaller area) in a case where a material is separated into multiple phases, or characteristic quantities based on these physical quantities. These quantities are examples, and other physical quantities may be used.

In the twin-screw extruder 100, examples of the operating condition D that depends on the position x include a set heater temperature and a screw configuration at the position of the cylinder. In a case where the operating condition D is used as an input, it is necessary to prepare simulation data in advance according to possible condition levels for the screw type and the set heater temperature, and to prepare a surrogate model database that has been trained using the data as training data.

In both of the cases illustrated in FIGS. 3A and 3B, all values on the output side are present on the input side. Specifically, characteristic quantities that are output from each type of element model include all characteristic quantities that are input to each type of the element model. By imposing this constraint on the surrogate models, the positions of the surrogate models arranged in series become interchangeable, and permutation optimization calculation can be performed by the search unit.

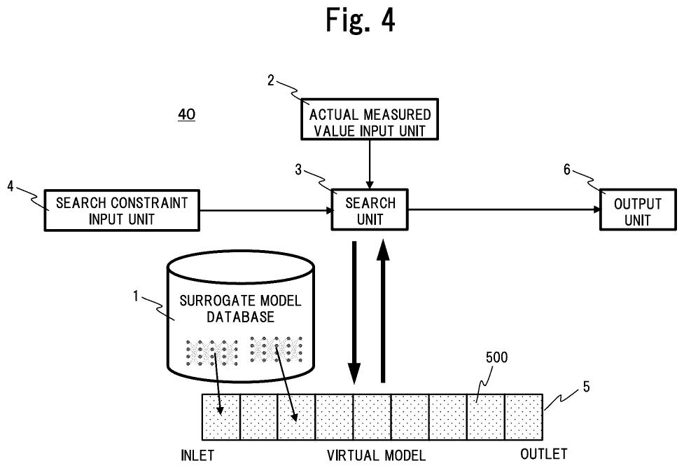

FIG. 4 is a functional block diagram of an internal process estimation system according to the embodiment. The internal process estimation system 40 can be configured as a general information processing apparatus, as described later.

As a result of an actual machine experiment using the twin-screw extruder 100, true values (actual measured values) obtained by the thermometer 101 and the pressure gauge 102 are input by an actual measured value input unit 2. Although it is possible to use only one of these two values, it is desirable to use the two values, and a value obtained by another measurement unit may also be added.

The search unit 3 uses input from the actual measured value input unit 2 to search for the order of the surrogate models 7 within the virtual model 5 in order to estimate a process occurring inside the twin-screw extruder 100. Therefore, for example, the search unit 3 searches for a permutation of the surrogate models 7 so as to minimize an evaluation function based on differences from the actual measured values.

A search constraint input unit 4 is an optional function unit that can reduce the amount of searching performed by the search unit 3. In the virtual model 5, element regions 500 in which the surrogate models are disposed are arranged in series. If the number N of element regions 500 in the virtual model 5 is large and many types of physical process element names are present, a full search by the search unit 3 imposes a heavy calculation load. Therefore, by defining a user-defined constraint in the search constraint input unit 4, it is possible to reduce unnecessary calculation of a model combination permutation.

As an example of the user-defined constraint in the present embodiment, by inputting knowledge that “no chemical change occurs before a solid melts” to the search constraint input unit 4, virtual model calculation for a surrogate model combination permutation in which the chemical change process occurs upstream of the solid heating and melting process as the order of a combination of surrogate models is skipped. Therefore, when a search algorithm performed by the search unit 3 is a full search, it is possible to reduce the amount of calculation to half.

The user-defined constraint can be freely set by the user empirically or by the user referring to literature, and it is preferable that the user-defined constraint be able to be input via the search constraint input unit 4 from outside the internal process estimation system 40 as appropriate.

By the calculation performed by the search unit 3, a virtual model is constructed by combining the surrogate models 7 in series. By calculation using the virtual model, the pressure and the temperature when the raw material fed from the upstream of the twin-screw extruder 100 at room temperature is ejected from the outlet are predicted.

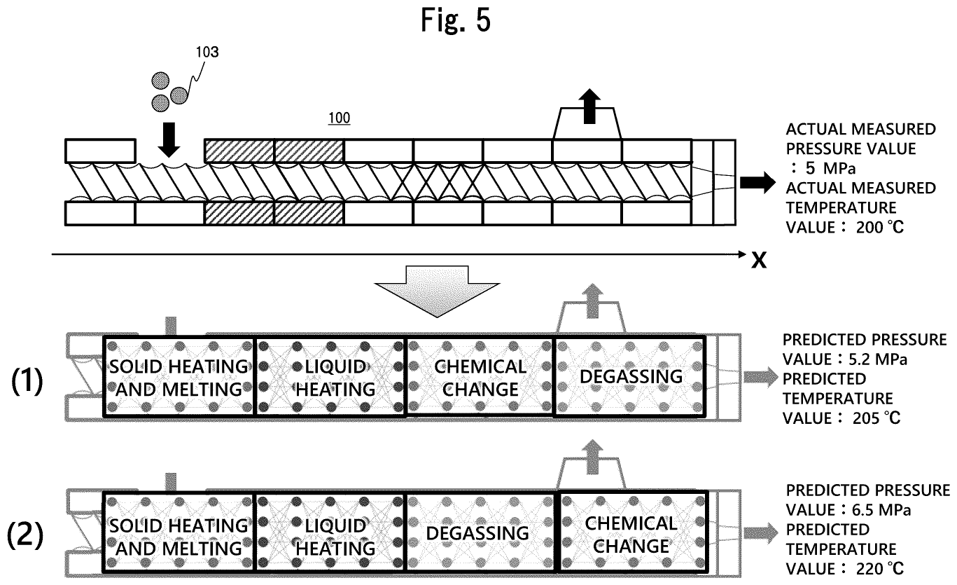

FIG. 5 illustrates predicted values of the pressure and the temperature for two types of virtual models in a case where the number of element regions N is 4 for ease of understanding. In practice, calculation is performed for a virtual model that includes not only two combinations (1) and (2) in FIG. 5, but also all physical process element surrogates in all the four element regions without violation of the user-defined constraint. That is, in the example illustrated in FIG. 5, the user-defined constraint that “no chemical reaction occurs before melting” is imposed and the amount of calculation can be reduced to half of 4\hat{ }4 virtual models in a case where the constraint is not present, and 4\hat{ }4/2=128 virtual models are possible. In this case, two virtual models are shown as surrogate model combinations in which the order in which the chemical change and the degassing are combined is reversed.

Predicted values and actual values of the two virtual models are compared. The virtual model (1) in which the chemical change is combined upstream takes a predicted pressure value and a predicted temperature value that are closer to the actual measured pressure value and the actual measured temperature value input from the actual measured value input unit 2.

It is conceivable that the process resolution is increased as the number of element regions N is set to a larger value. Based on this, the amount of calculation in the search unit 3 is reduced by appropriately setting the user-defined constraint. The search unit 3 sorts all calculation results in order of the proximity between the predicted values and the actual measured values. In a case where a plurality of predicted values are present, the values may be standardized by using all values of the calculated results to make the scale uniform, or the values may be multiplied by a user-defined coefficient and summed, and then sorted.

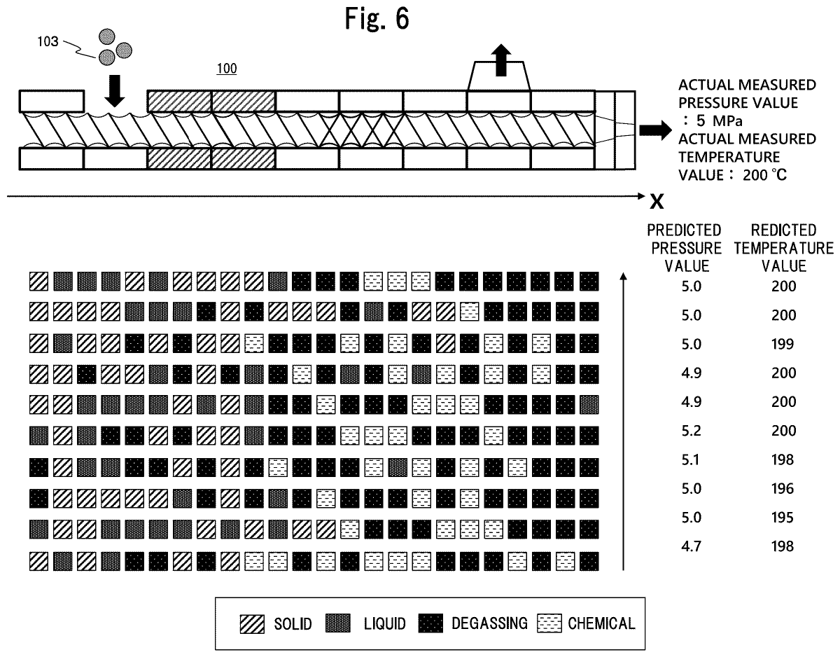

FIG. 6 is a schematic diagram illustrating results of sorting predicted values calculated by the search unit 3 in order of proximity to the actual measured values when N=24. In a case where N is a large value, a wide variety of virtual models return predicted values that are nearly identical to the actual measured values. This is due to the fact the degree of freedom in a permutation of combinations of the surrogate models is very high, which increases the possibility that a permutation that causes predicted results simply show values close to the actual measured values may appear.

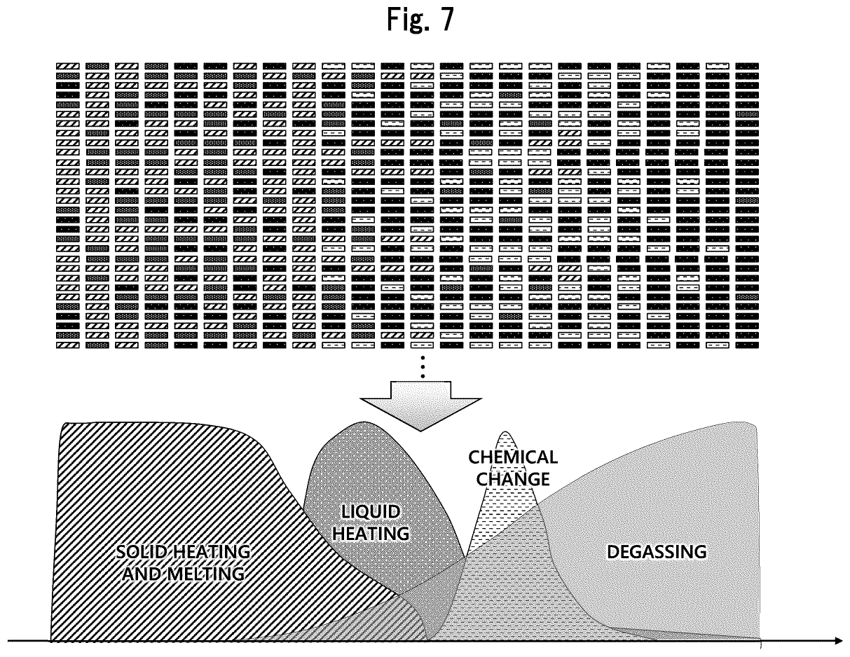

FIG. 7 illustrates results of the search and sorting performed by the search unit 3 that are visualized by the output unit 6 as a histogram showing the frequency of appearance of surrogate models at each position according to a threshold value (for example, the top 1%) given by the user. From this histogram, the user can imagine the following process.

In creating a histogram, in addition to the user specifying a percentile to be integrated as described above, it is also conceivable to integrate values by assigning a greater weight to a higher ranking, or to specify an allowable deviation from the actual measured value and perform integration within a specified range, and these options may be selected according to the configuration of the apparatus and purpose.

In the example illustrated in FIG. 7, first, the input raw material is heated and melted while being still solid, and continues to be heated even after the raw material becomes liquid. Thereafter, the raw material undergoes a chemical change and is subjected to degassing. In this case, a certain section where a solid and a liquid coexist is present, and from around this section, degassing actually begins continuously in parallel with all processes, and degassing always occurs from the start to the end of the chemical change. In addition, the state of the system is a liquid state, and even after the chemical change, the temperature continues to rise slightly in the liquid state.

In the examples illustrated in FIGS. 6 and 7, the constraint set in the search constraint input unit 4 imposes a constraint condition such that the chemical surrogate model is not present before the solid melting surrogate model, thereby reducing the amount of calculation.

In the present embodiment, it is possible to estimate a phenomenon occurring in the apparatus and visualize a process. Therefore, for example, by checking a difference in process order when a desired result is obtained using the actual machine and when the desired result is not obtained, it is possible to estimate the reason why the desired result is not obtained.

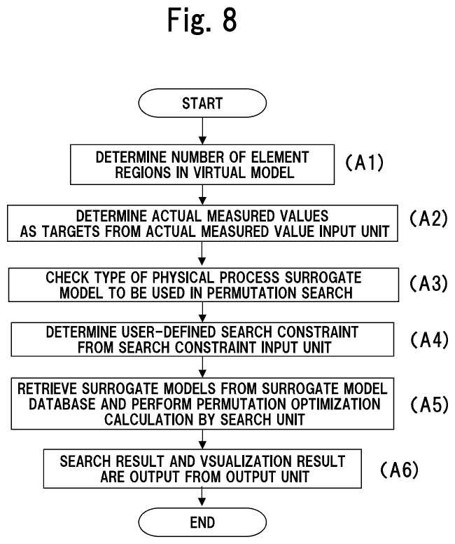

FIG. 8 is a flowchart illustrating a procedure from start to output of an estimated internal process permutation. The operating principle of a system that outputs the estimated internal process permutation will be described below with reference to the flowchart of FIG. 8.

First, the number N of element regions in a virtual model is determined (A1). As the number N, a value specified by the user may be used, or a value registered as an initial value in any of storage devices may be used. The value specified by the user is input from an input device 44 described later.

Thereafter, actual measured values serving as targets are determined from the actual measured value input unit 2 (A2). In the case of the twin-screw extruder illustrated in FIG. 1, the actual measured values are, for example, values measured by the thermometer 101 and the pressure gauge 102 when the predetermined raw material 103 is fed into the apparatus under a predetermined condition and the raw material 103 becomes a molten resin and is ejected from the outlet 109. The actual measured values can be measured by the actual machine using a known method. Any number of types of actual measured values may be used, but the actual measured values need to be physical quantities that can be output by the surrogate models 7.

Thereafter, the search unit 3 refers to the surrogate model database 1 and checks the type of physical process surrogate model to be used in a permutation search (A3). For this operation, it is necessary to select a physical process that can be understood by the user.

Therefore, a user-defined search constraint is determined from the search constraint input unit 4 (A4). The user-defined search constraint is used to shorten the calculation time and does not need to be entered. In this case, the types of surrogate models to be used by the search unit 3 may be limited.

Thereafter, the search unit 3 retrieves the surrogate models 7 from the surrogate model database 1 and performs permutation optimization calculation (A5). The search unit 3 creates a plurality of virtual models by applying the plurality of types of surrogate models 7 to the plurality of element regions in a plurality of orders in accordance with the constraint condition. Thereafter, in the case of the twin-screw extruder illustrated in FIG. 1, conditions for feeding the raw material 103 when the actual measured values are obtained are used as inputs for the plurality of virtual models, and outputs (estimated values) are obtained. The feeding conditions are, for example, the temperature and the pressure.

The search unit 3 performs evaluation by comparing the actual measured values with the plurality of estimated values as illustrated in FIG. 6. If the number of types of surrogate models corresponding to physical processes and N are large, a search algorithm other than a full search may be used by a method such as Bayesian optimization using user settings or results of previous processing as initial values without trying all combinations.

Thereafter, the output unit 6 (the output device 45 described later) outputs search results and visualization results (A6). For example, a histogram image as illustrated in FIG. 7 is displayed on a screen of the output device 45. The order of A1 to A4 is any order as long as A1 to A4 are performed before A5.

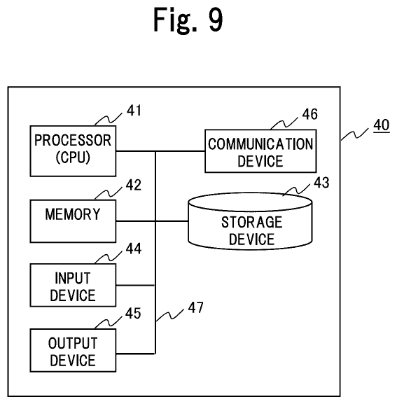

FIG. 9 is a block diagram illustrating a hardware configuration of the internal process estimation system 40. The internal process estimation system 40 is implemented by an information processing apparatus including a processor (CPU) 41, a memory 42, a storage device 43, the input device 44, the output device 45, a communication device 46, and a bus 47 as main components.

The processor 41 functions as a functional unit (functional block), which provides a predetermined function, by executing processing in accordance with a program loaded into the memory 42. The storage device 43 stores data to be used by the functional unit in addition to the program that causes the processor 41 to function as the functional unit. As the storage device 43, for example, a nonvolatile storage medium such as a hard disk drive (HDD) or a solid-state drive (SSD) is used. The input device 44 is a keyboard, a pointing device, or the like, and the output device 45 is a display or the like. The communication device 46 is capable of communicating with another information processing apparatus via a network. These devices are communicably connected to each other via the bus 47.

In the present embodiment, functions equivalent to the functions configured as software may be implemented by hardware such as a field programmable gate array (FPGA), an application specific integrated circuit (ASIC), or a graphics processing unit (GPU). Such an aspect includes the scope of the embodiments.

The internal process estimation system 40 may not be implemented by a single information processing apparatus and may be implemented by a plurality of information processing apparatuses. One or more or all of the functions of the internal process estimation system 40 may be implemented as an application on a cloud.

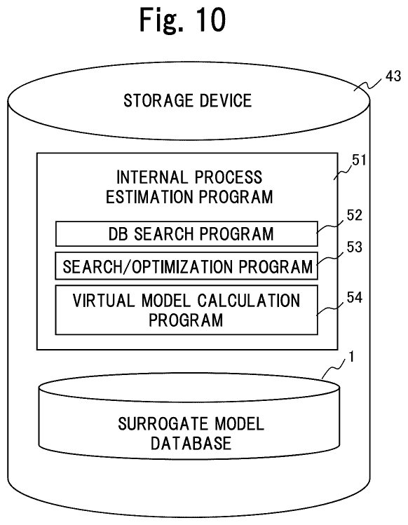

FIG. 10 illustrates a program and data stored in the storage device 43. An internal process estimation program 51 is loaded into the memory 42 and executed by the processor 41 so as to cause the processor 41 to function as the search unit 3. The internal process estimation program 51 includes, as sub-programs, a database (DB) search program 52, a search/optimization program 53, and a virtual model calculation program 54. These sub-programs are also loaded into the memory 42 and executed by the processor 41 so as to cause the processor 41 to function as a DB search unit, a search/optimization unit and a virtual model calculation unit. In addition, the surrogate model database 1 used by the internal process estimation system is stored in the storage device 43.

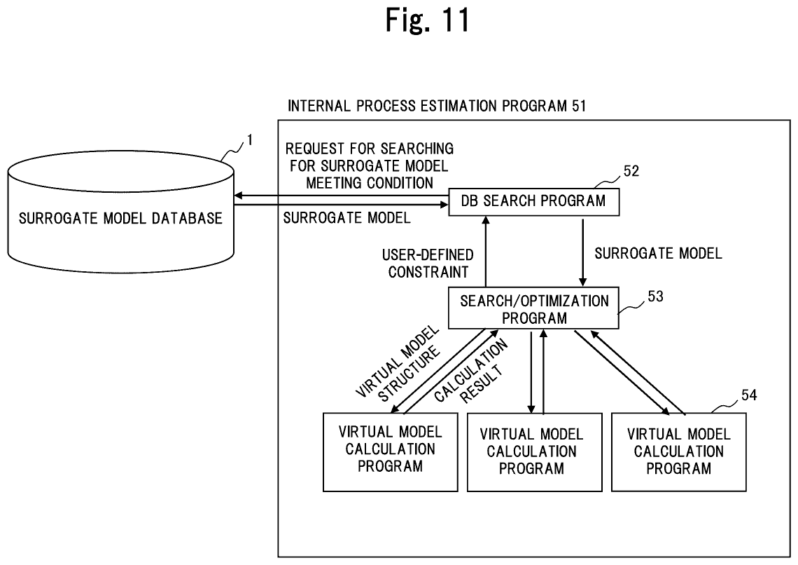

FIG. 11 illustrates operations of the sub-programs of the internal process estimation program 51. The DB search program 52 refers to the surrogate model database 1 and specifies a surrogate model to be used. As a specific example, the DB search program 52 has a function of causing the output device 45 to display the content of the surrogate model database 1 and allowing the user to specify, from the input device 44, a surrogate model to be used. In this case, a condition and a definition constraint for the surrogate model to be applied may be specified from the input device 44.

The search/optimization program 53 lists candidates for possible combinations of surrogate models (that is, virtual models that do not violate the user-defined constraint) and summarizes and visualizes calculation results. The search/optimization program 53 can be provided with a function of searching for a virtual model that best represents an internal process of the actual apparatus from among a plurality of virtual models, and optimizing the virtual model.

The virtual model calculation program 54 causes a virtual model created by the search/optimization program 53 to perform inference calculation. The inference calculation can be performed independently of and in parallel with calculations of the DB search program 52 and the search/optimization program 53.

The surrogate models are mainly intended to be constructed using deep learning modeling such as a neural network, but even performing inference using only one type (that is, obtaining an output for a predetermined input) of surrogate model can take several seconds to several tens of seconds depending on the size of the model. Therefore, as illustrated in FIG. 10, it is preferable to simultaneously execute a plurality of virtual model calculation programs 54 in parallel to alleviate the bottleneck in the execution time of the entire program (internal process estimation program 51).

In addition, in the present embodiment, increasing the number N of element regions improves the process resolution, but increases the processing time for search/optimization. A method for reducing the processing time is to apply the constraint condition as described above. As another method, it is conceivable that virtual model calculation is randomly performed, the output device 45 displays rankings as illustrated in FIG. 6 in real time or at a predetermined interval, it is determined that optimization has been achieved when the rankings have stabilized to a certain extent, and the user stops the virtual model calculation by issuing an instruction from the input device 44 at his/her discretion. The virtual model calculation may be automatically stopped under a predetermined condition instead of the user.

Instead of randomly executing the virtual model calculation, it is also conceivable to use the search/optimization program 53 to create a list of calculation candidates, which is not exhaustive but rough, in advance using design of experiments (DoE) or the like, without an overlap in virtual models, and then issue a calculation instruction to the virtual model calculation program 54.

As another specific example, the list of the virtual models as the calculation candidates in the DoE is determined as an initial value, and it is checked whether the accuracy of the virtual models is improved by replacing a small number (for example, one surrogate model) of surrogate models from a permutation of surrogate models of the virtual models as the initial value. If the accuracy is improved, the initial value is repeatedly replaced. When the permutation of the virtual models has been examined to the point where simply replacing one model does not improve the accuracy of the virtual models, it can be said that a local optimum solution has been found from the initial value. The search/optimization program 53 may be configured to automatically execute the above-described process.

### Second Embodiment

The example of the twin-screw extruder has been described above, but the embodiment is not limited to the twin-screw extruder and is applicable to another apparatus. A single-screw extruder, which is another type of extruder, or a completely different apparatus may be used. For example, in the production of Japanese sake, saccharification by koji mold and fermentation by yeast occur simultaneously. It is difficult to measure physical phenomena inside a brewing tank from the outside. Therefore, it is possible to substitute a surrogate model for a simulation of physical phenomena in a target apparatus, and estimate the order of internal processes using the same method as in the above-described embodiment.

According to the embodiment, since it is possible to estimate processes occurring inside the apparatus without conducting an experiment using the actual machine, the apparatus can consume less energy, reduce carbon emissions, and contribute to prevention of global warming and the realization of a sustainable society.

### REFERENCE SIGNS LIST

1: surrogate model database
2: actual measured value input unit
3: search unit
4: search constraint input unit
5: virtual model
6: output unit
7: surrogate model
11: input substance state quantity
12: output substance state quantity
13: operating condition D
40: internal process estimation system
41: processor (CPU)
42: memory
43: storage device
44: input device
45: output device
46: communication device
47: bus
51: internal process estimation program
52: database search program
53: search/optimization program
54: virtual model calculation program
101: thermometer
102: pressure gauge
103: raw material
104: conveyance screw
105: melting zone
106: kneading zone
107: degassing port
108: die
109: outlet

What is claimed is:

1. An internal process estimation system comprising a search unit, an actual measured value input unit, and an output unit, wherein
the search unit applies, in a plurality of orders, a plurality of types of element models to a plurality of element regions of a virtual model divided into the plurality of element regions continuously in a single direction and creates a plurality of virtual models that simulate a process of a state transition from a first state to a second state of an actual apparatus,
the actual measured value input unit inputs an actual measured value in the second state of the actual apparatus,
the search unit evaluates the virtual model based on a difference between predicted data output by inputting a value based on the first state to the plurality of virtual models and the actual measured value, and
the output unit outputs a result evaluated by the search unit.

2. The internal process estimation system according to claim 1, wherein
the element models are estimation models that substitute for a simulation of a physical process.

3. The internal process estimation system according to claim 1, wherein
an output of each of the plurality of types of element models includes all of inputs of a corresponding one of the types of element models.

4. The internal process estimation system according to claim 1, wherein
the search unit ranks the plurality of virtual models in ascending order of the difference between the predicted data and the actual measured value.

5. The internal process estimation system according to claim 1, further comprising:
a search constraint input unit that receives an input of a user-defined constraint, wherein
the search unit applies the plurality of types of element models to the plurality of element regions under the user-defined constraint.

6. The internal process estimation system according to claim 1, wherein
each of the element models is at least a model selected from a surrogate model constructed by machine learning and a regression model capable of analytically describing a relationship between values.

7. The internal process estimation system according to claim 1, wherein
each of the element models simulates at least a physical process selected from four physical processes that are a liquid heating process, a solid heating and melting process, a degassing process, and a chemical change process.

8. The internal process estimation system according to claim 1, wherein
the element models are surrogate models that simulate a process of a state transition of at least a substance selected from a fluid and a fine powder, and
training data used by the surrogate models for training is a result of numerically calculating an equation of motion.

9. The internal process estimation system according to claim 1, wherein
the output unit outputs, in a histogram format, an order of element models assigned to a plurality of element regions of a plurality of virtual models for which the difference between the predicted data and the actual measured value satisfies a predetermined condition.

10. The internal process estimation system according to claim 1, wherein
the actual apparatus is an extruder, the first state is a state of a substance at an inlet of the extruder, the second state is a state of the substance at an outlet of the extruder, and the actual measured value is a value of at least one of a pressure of the substance and a temperature of the substance.

11. The internal process estimation system according to claim 1, wherein
the search unit includes a plurality of virtual model calculation units that input and output a value based on the first state to the plurality of virtual models, and causes the plurality of virtual model calculation units to operate in parallel.

12. An internal process estimation method comprising being executed by an information processing apparatus that includes a search unit, an actual measured value input unit, and an output unit,
the search unit applying, in a plurality of orders, a plurality of types of element models to a plurality of element regions of a virtual model divided into the plurality of element regions continuously in a single direction and creates a plurality of virtual models that simulate a process of a state transition from a first state to a second state of an actual apparatus,
the actual measured value input unit inputting an actual measured value in the second state of the actual apparatus,
the search unit evaluating the virtual model based on a difference between predicted data output by inputting a value based on the first state to the plurality of virtual models and the actual measured value, and
the output unit outputting a result evaluated by the search unit.

13. The internal process estimation method according to claim 12, wherein
the element models are estimation models that substitute for a simulation of a physical process.

14. The internal process estimation method according to claim 12, wherein
an output of each of the plurality of types of element models includes all of inputs of a corresponding one of the types of element models.

15. The internal process estimation method according to claim 12, wherein
each of the element models is at least a model selected from a surrogate model constructed by machine learning and a regression model capable of analytically describing a relationship between values.
